(19) United States
(12) Patent Application Publication
(10) Pub. No.: US 2018/0229995 A1
(43) Pub. Date: Aug. 16, 2018

(54) FUEL TRANSFER AND MONITORING SYSTEM

(71) Applicant: LUIGI PICCIONE, LITTLE RIVER, SC (US)

(72) Inventor: LUIGI PICCIONE, LITTLE RIVER, SC (US)

(21) Appl. No.: 15/434,079

(22) Filed: Feb. 16, 2017

(51) Int. Cl. B67D 7/32; B67D 7/04; B67D 7/34; B67D 7/14

(52) U.S. Cl. CPC B67D 7/3209; B67D 7/04; B67D 7/3272; B67D 7/145; B67D 7/346; B67D 7/348; B67D 7/3281

(57) ABSTRACT

The present invention relates to incorporating a RFID chip and at least one sensor which contains a universal safe fuel transfer code and enable pumping the fuel only using the RFID Chip and the at least one sensor, wherein the at least one sensor detects whether the dispensing unit is connected to the receiving unit and further authenticates the universal fuel transfer code to signal a safe and leakage-free fuel transfer path for the fuel.

### FIELD OF INVENTION

The present invention relates to a fuel/transfer monitoring system to provide a safe channel or a safe passageway to enable a leakage-free fuel transfer system, also the present invention enables preventing the unauthorized use of fuel pumping and transfer equipment.

### BACKGROUND OF THE INVENTION

The present invention deals with the transfer of fuels from one container to the other. During the fuel transfer process the likelihood of leaking is greatly increased as the fuel canisters are opened and fuel is moved through empty lines and into empty containers where back pressure and vapers can be created. Leaking fuel is at high risk of ignition as it is exposed to the atmosphere. Many fuels are also toxic to plant and animal life and can cause damage if leaked.

Frequently drivers will idle their vehicle while refueling or even drive away with the fueling hose still inserted in the vehicle. This is very hazardous, increasing the risk of leaks and ignition of the fuel vapers at the fueling site.

Also, the problem herein relates to unauthorized usage and transfer of fuel. If we consider the traditional way of pumping fuel and its usage by various fuel carrying equipment; there exists a lot of loop holes. Most of the fuel dispatched for use by a variety of people is dispensed by unauthorized way, as sufficient security and safety measures to prevent unauthorized use of fuels does not exist.

Therefore, there remains a need to overcome above mentioned problems and our invention resolve these entire problems.

### SUMMARY OF THE INVENTION:

In order to overcome the problems of the prior art the present invention provides a fuel transfer and monitoring system to provide a safe channel or a safe passageway to enable a leakage-free fuel transfer system also the invention helps in preventing the unauthorized use of fuel pumping and transfer equipment by making use of the universal safe fuel transfer code which enables the fuel transfer only when the at least one sensor senses the RFID chip coupled to the dispensing unit which further authenticates the universal safe fuel transfer code to dispense fuel from dispensing unit to the receiving unit.

A fuel transfer system herein comprises: a dispensing unit, having at least one RFID chip coupled to at least one end of the dispensing unit; a receiving unit, having at least one sensor coupled to at least one end of the receiving unit and wherein the dispensing unit dispenses the fuel to the receiving unit after the detection of the RFID chip by sensing the sensor, coupled to the at least one end of the receiving unit. The dispensing unit herein is at least one of a fuel pipelines, fuel pumps, fuel transfer lines or the combination thereof and the receiving unit herein is at least one of a fuel transfer trucks, marine equipment or the combination thereof.

In other embodiment of the invention, a series of sensors and safety shut offs are used in vehicles, fuel pumps, fuel transfer lines and any other application where fuel is transferred from one vessel to another.

### BRIEF DESCRIPTION OF THE DRAWINGS

The following drawings illustrates exemplary embodiment; however, they are helpful illustrating objects, features and advantages of the present invention because the present invention will be more apparent from the following detailed description taken in conjunction with accompanying drawings in which:

FIG. 1 illustrates the perspective view of the given invention as per an embodiment of the invention.

FIG. 2 illustrates the flow chart view of the given invention which is also the preferred embodiment of the invention.

### DETAIL DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further computationally implemented methods of the principles of the invention as illustrated therein being contemplated as would normally occur to one skilled in the art to which the invention relates.

References to “one embodiment,” “at least one embodiment(s),” “an embodiment,” “one example,” “an example,” “for example,” and so on indicate that the embodiment(s) or example(s) may include feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

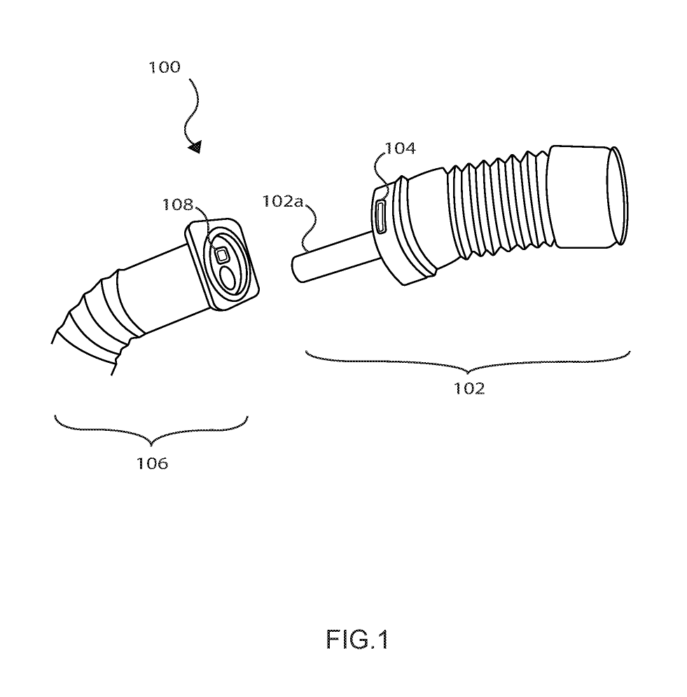

FIG. 1 illustrates the perspective view of the given invention as per an embodiment of the invention.

FIG. 1 illustrates a fuel transfer and monitoring system 100 which comprises a dispensing unit 102, having at least one RFID chip 104 coupled to at least one end 102a of the dispensing unit 102; a receiving unit 106, having at least one sensor 108 coupled to at least one end 106a of the receiving unit 106 and wherein, the dispensing unit 102 dispenses the fuel to the receiving unit 106 after the detection of the RFID chip 104, by sensing at least one sensor 108, coupled to the at least one end 106aof the receiving unit 106. The fuel transfer and monitoring system 100 herein is primarily concerned with safety, by preventing fuel from being dispensed into unauthorized containers which are regulated by the universal safe fuel transfer code that enables the fuel transfer only when the at least one sensor 108 senses the RFID chip 104 coupled to the dispensing unit 102 and further authenticates the universal safe fuel transfer code to dispense fuel from the dispensing unit 102 to the receiving unit 106. Further the fuel transfer and monitoring system 100 prevents ignition of vehicles by simply shutting the ignition off for the vehicles engine to reduce the risk of explosion at the time the driver is driving away with the dispensing unit 102 still attached to the receiving unit 106. A dispensing unit 102 herein, is enabled to pump the fuel only by use of the RFID chip 104 and only when the RFID chip 104 detects that the dispensing unit 102 and receiving unit 106 is in proper contact. Further, the dispensing unit 102 incorporated with a RFID chip 104 authenticates the dispensing unit 102 after detecting the RFID chip 104 and further produces the dispense command in response to the authentication of the universal fuel transfer code of the RFID chip 104 indicating no leakage passageway or proper contact of the dispensing unit 102 with the receiving unit 106 at a time of receiving the fuel. The fuel transfer and monitoring system 100 herein detects the presence of an inserted dispensing unit 102 either by mechanical switch or RFID chip 104. If the at least one sensor 108 detects the presence of a dispensing unit 102 in contact with the receiving unit 106, the vehicle disables the ignition system and prevents the vehicle from starting while being fueled. Also, the at least one sensor 108 used in the fuel transfer and monitoring system 100 is a position sensor enabled to detect the position/location of the RFID chip 104 and thereafter perform the work respectively. The fuel transfer and monitoring system 100 also provides an alarm system for the vehicle indicating no leakage passes way and proper contact of the dispensing unit 102 with the receiving unit 106.

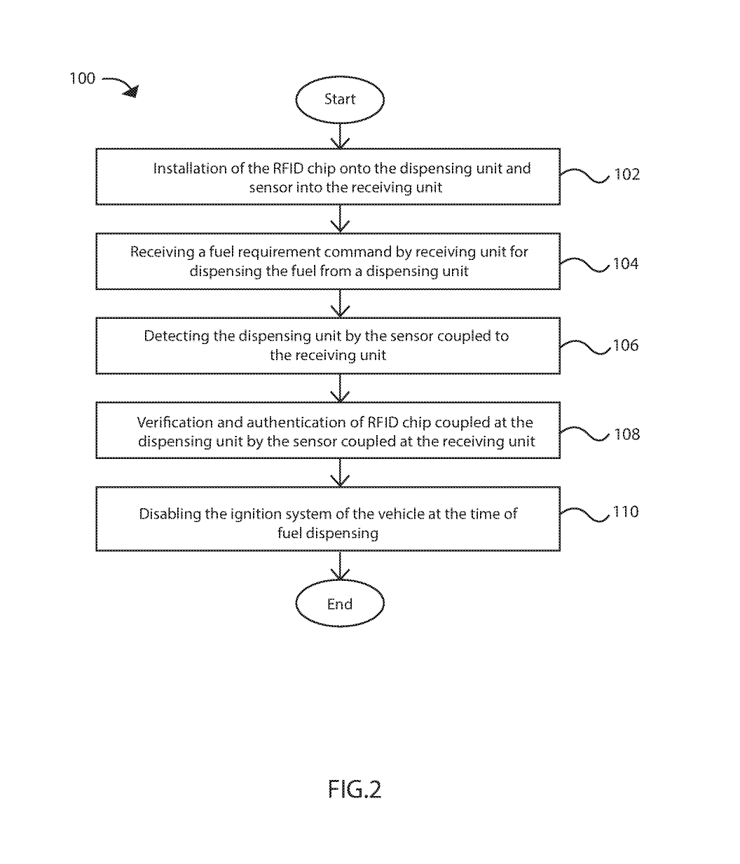

FIG. 2 illustrates the flow chart view 100 of the given invention which is also the preferred embodiment of the invention.

Step. 102 of FIG. 2 illustrates incorporating the RFID chip onto the dispensing unit and at least one sensor programmed with a universal safe fuel transfer code into the receiving unit, wherein the process of installation of the RFID chip and the at least one sensor on the two units is an easy and a manual process and do not require any mechanical skill. Any person with ordinary skill in mechanics is enabled to do the process of installation very easily. The at least one sensor and the RFID chip is either removably coupled or is integrally coupled with the fuel transfer and monitoring system, wherein the choice of coupling depends upon the at least one user's choice and need.

Step. 104 of FIG. 2 illustrate receiving a fuel requirement command for dispensing fuel from a dispensing unit to a receiving unit respectively; wherein the fuel requirement command is given by the receiving unit enable to receive fuel.

Step. 106 of FIG. 2 illustrate detecting the dispensing unit by the at least one sensor coupled at the receiving unit, wherein the at least one sensor herein is incorporated with a universal fuel transfer code. Also, the at least one sensor used herein is a position sensor which detects the exact position of the dispensing unit in order make a proper and gap free passageway for dispensing the fuel from the dispensing unit to the receiving unit.

Step. 108 of FIG. 2 illustrate verification and authentication of the dispensing unit after detecting the RFID chip coupled at the dispensing unit and further produce the final dispense command in response to the authentication of the universal fuel transfer code of the at least one sensor indicating no leakage passageway or proper contact of the dispensing unit with the receiving unit at a time of receiving the fuel. The authentication ways for the universal fuel transfer code is automatic, wherein each dispensing unit with a RFID chip is incorporated with authentication code to match and authenticate the universal safe fuel transfer code on been detected by the at least one sensor. The at least one sensor authenticates the dispensing unit after detecting the RFID chip and further produce the final dispense command in response to the authentication of the universal safe fuel transfer code of the fuel, indicating no leakage passageway or proper contact of the dispensing unit with the receiving unit at a time of receiving the fuel.

Step. 110 of FIG. 2 illustrate disabling the ignition system of the vehicle in order to prevent the vehicle from starting while being fueled and therefore prevent the vehicle from any mishap at the time of fueling.

The fuel transfer and monitoring system enable providing a secured dispensing and receiving of the fuel by the help of the dispensing unit and the receiver unit, wherein the dispensing unit of the fuel transfer and monitoring system is at least one of a fuel pipelines, a fuel pumps, a fuel transfer lines or the combination thereof and the receiving unit of the fuel transfer and monitoring system is at least one of a fuel transfer trucks, marine equipment nor the combination thereof.

What is claimed:

1. A fuel transfer system comprises:
a. a dispensing unit, having at least one. RFID chip coupled to at least one end of the dispensing unit;
b. a receiving unit, having at least one sensor coupled to at least one end of the receiving unit; and
wherein the dispensing unit dispenses the fuel to the receiving unit after the detection of the RFID chip, coupled to the at least one end of the dispensing unit, by the sensor, coupled to the at least one end of the receiving unit.

2. The fuel transfer system in claim 1; wherein the receiving unit is at least one of a fuel vessel, fuel transfer trucks, marine equipment or the combination thereof.

3. The fuel transfer system in claim 1; wherein the dispensing unit is at least one of a fuel pipelines, a fuel pumps, a fuel transfer lines or the combination thereof.

4. The fuel transfer system in claim 1; wherein the at least one sensor and the RFID chip is either removably coupled or is integrally coupled with the fuel transfer system.

5. The fuel transfer system in claim 1; wherein the at least one sensor used herein is a position sensor detecting the exact position of the dispensing unit.

6. The fuel transfer system in claim 1; wherein fuel transfer system is also enabled to disable the ignition system of a vehicle, preventing the vehicle from starting while being fueled.

7. The fuel transfer system in claim 1; wherein the at least one sensor detects the presence of an inserted dispensing unit mechanically by the help of a mechanical switch.

8. The fuel transfer system in claim 1; wherein the at least one sensor produce a dispense command in response to an authentication of a universal fuel transfer code associated with the at least one sensor indicating no leakage passageway or proper contact of the dispensing unit with the receiving unit at a time of receiving the fuel.

9. The fuel transfer system in claim 1; wherein the fuel transfer system also provides an alarm system for the vehicle and for the fuel transfer system too indicating no leakage passageway and proper contact of the dispensing unit with the receiving unit.

10. A method for fuel monitoring comprises the steps of:
a. receiving a dispense command via receiving unit coupled to at least one sensor on detection of a RFID chip, coupled to a at least one end of a dispensing unit; and
b. dispensing the fuel to the receiving unit via dispensing unit in response to an authentication of a universal fuel transfer code associated with the at least one sensor indicating no leakage passageway or proper contact of the dispensing unit with the receiving unit at a time of receiving the fuel.

11. The method in claim 10; wherein the receiving unit is at least one of a fuel transfer trucks, marine equipment or the combination thereof.

12. The method in claim 10; wherein the dispensing unit is at least one of a fuel pipelines, a fuel pumps, a fuel transfer lines or the combination thereof.

13. The method in claim 10; wherein the at least one sensor and the RFID chip is either removably coupled or is integrally coupled with the fuel transfer system.

14. The method in claim 10; wherein the at least one sensor used herein is a position sensor detecting the exact position of the dispensing unit.

15. The method in claim 10; wherein the method is also enabled to disable the ignition system of a vehicle, preventing the vehicle from starting while being fueled.

16. The method in claim 10; wherein the at least one sensor detects the presence of an inserted dispensing unit mechanically by the help of a mechanical switch.

17. The method in claim 10; wherein the method also provides an alarm system for the vehicle and for the fuel transfer system too indicating no leakage passageway and proper contact of the dispensing unit with the receiving unit.

18. A fuel transfer system comprises:
a. a dispensing unit, having at least one RFID chip coupled to at least one end of the dispensing unit;
b. a receiving unit, having at least one sensor coupled to at least one end of the receiving unit; and
wherein the dispensing unit dispenses the fuel to the receiving unit after the detection of the RFID chip, coupled to the at least one end of the dispensing unit, by the sensor, coupled to the at least one end of the receiving unit and, wherein the fuel transfer system further disables an ignition system of a vehicle, preventing the vehicle from starting while being fueled.
